(19) United States
(12) Patent Application Publication
(10) Pub. No.: US 2007/0142062 A1
(43) Pub. Date: Jun. 21, 2007

(54) Satellite simulation model system based on interface standard model

(76) Inventors: Sung-Ki Cho, Daejon (KR); Sang-Uk Lee, Daejon (KR); Jae-Hoon Kim, Daejon (KR); Seong-Pal Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/582,425

(22) PCT Filed: Dec. 13, 2004
(86) PCT No.: PCT/KR04/03274

§ 371 Date: Jun. 9, 2006

(30) Foreign Application Priority Data
Dec. 12, 2003 (KR) 10-2003-0090766

(51) Int. Cl. H04Q 7/20

(52) U.S. Cl. 455/456.3

(57) ABSTRACT

A satellite simulation model system based on an interface standard model is disclosed. The system includes a satellite subsystem standard model for simulating operations of physical satellite subsystems; a flight software module for generating a control signal changing operation state of the satellite subsystem standard model; an interface standard model for converting data transmitted from the satellite subsystem standard model and the flight software module into data to receiving components and transmitting the converted data to the receiving components; and a model managing unit for generating the satellite subsystem standard model and the interface standard model as independent component objects and controlling each component object to perform satellite simulation.

### TECHNICAL FIELD

The present invention relates to a satellite simulatin model system based on an interface standard model; and, more particularly, to a satellite simulation modeling system for modeling each satellite subsystem and interface asan independent object by using a model managing unit, converting command data transmitted from a flight software module and a satellitesubsystem standard model based on the interface standard model and transmitting the converted data to coresponding units.

### BACKGROUND ART

In recent, as a satellite technology develops, a satellite can be controlled to fly in rotate according to its mission orbit above the earth and to collect information. The information collected by the satellite is utilized in various application fields, e.g., resource exploration, weather state measurement and military information collection.

The satellite subsystems include hardware units, e.g., a satellite structural mechanism, an actuator and a sensor and a satellite onboard computer including software, e.g., flight software for controlling the satellite subsystems and changing trajectories, a velocity and attitude maneuvers for tracking observing object of the satellite.

In order to change a satellite state, a ground spacecraft control center transmits telecommand data to the satellite onboard computer, and then the satellite onboard computer processes the received telecommand data and transmits a control command which controls corresponding devices to the satellite subsystems. The satellite subsystems operate according to the control signal in order to change the satellite state, and then feedback results, e.g., telemetry data to the satellite onboard computer. Then, the satellite onboard computer processes the telemetry data and transmits the telemetry data in a specified format to the ground spacecraft control center. Herein, the data are mutually exchanged between the satellite onboard computer and the satellite su bsystems based on various interface schemes according to characteristics of the satellite subsystems and the satellite onboard computer.

Meanwhile, the modeling of each subsystem in the satellite subsystems is performed as software in a most similar environment to an actual environment, and satellite simulation data is exchanged between the satellite subsystem model and the satellite onboard computer through the interface, and then the satellite is simulated. Wherein, because the satellite simulation data volume is enormous and also each subsystem does not meet a standard, the interface that connects the software of the satellite onboard computer and the satellite subsystem model (hereinafter, refers to as the software interface) affects to performance and implementation efficiency of the satellite simulation system.

The conventional technology as mentioned above analyzes the interface of the satellite, implements the interface based on analyzed data as software and performs the modeling of the satellite subsystems to be connected and flight software to be connected to each other as software, and the satellite simulation data are mutually exchanged through the software interface.

However, the conventional technology analyzes an actual interface structure and functions of the satellite, to thereby implement the satellite subsystem model and the flight software based on a standard of the analyzed interface. Thus, an actual interface and organization of the satellite subsystems and the flight software are not matched, and the simulation cannot be performed precisely.

Also, there is a problem in the conventional technology as followings. If the satellite simulation data or the transmission scheme is changed, e.g., the satellite subsystem is changed to another kind of equipment or the flight software is upgraded for performance improvement, all program of the satellite simulation system must be modified in order to reflect the changes to the satellite subsystems, the interface and the flight software.

### DISCLOSURE OF INVENTION

### Technical Solution

It is, therefore, an object of the present invention to solve the problem and provide to a satellite simulation modeling system for modeling each satellite subsystem and an interface as an independent object by using a model managing unit, converting command data transmitted from a flight software module and a satellite subsystem standard model based on the interface standard model and transmitting the converted data to corresponding units.

In accordance with an aspect of the present invention, there is provided a satellite simulation model system based on an interface standard model, the system including: a satellite subsystem standard model for performing operations of physical satellite subsystems; a flight software module for generating a control signal changing operation state of the satellite subsystem standard model; an interface standard model for converting data transmitted from the satellite subsystem standard model and the flight software module into data to receiving components and transmitting the converted data to the receiving components; and a model managing unit for generating the satellite subsystem standard model and the interface standard model as independent component objects and controlling each component object to perform satellite simulation.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a satellite simulation modeling system in accordance with a preferred embodiment of the present invention; and

FIG. 2 is a detail block diagram showing a satellite simulation modeling system in accordance with a preferred embodiment of the present invention.

### BEST MODE FOR CARRYING OUT THE INVENTION

Hereinafter, an apparatus and a method for transmitting/receiving destination wake-up information will be described in detail with reference to the accompanying drawings.

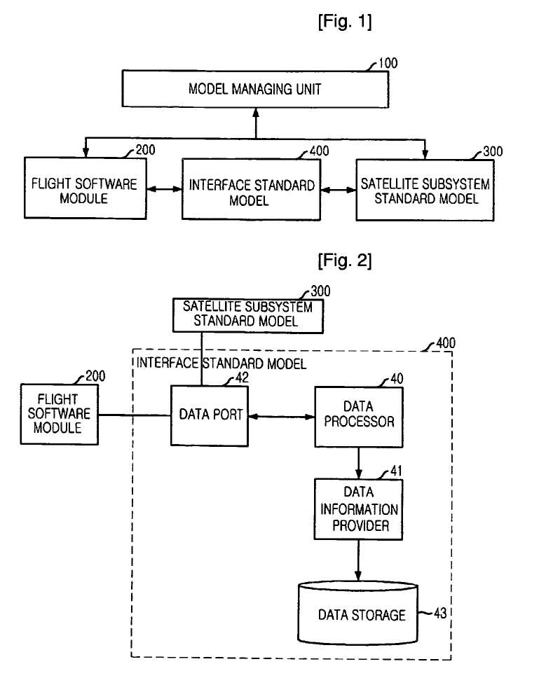

FIG. 1 is a block diagram showing a satellite simulation modeling system in accordance with a preferred embodiment of the present invention.

As shown, the satellite simulation modeling system in accordance with a preferred embodiment of the present invention includes a model managing unit 100, a flight software module 200, a satellite subsystem standard model 300 and an interface standard model 400.

The model managing unit 100 generates the satellite subsystem standard model 300 and the interface standard model 400, initializes each component and controls each component in order to perform a satellite simulation. Also, the model managing unit 100 manages data processing information and data link information, which are included when the interface standard model 400 is generated, in order to convert the data transmitted from the flight software module 200 and the satellite subsystem standard model 300, the data to the receiving component in the interface standard model 400.

Also, when a physical satellite subsystem is changed, the model managing unit 100 generates the satellite subsystem standard model 300 corresponding to the changed satellite subsystem and allocates the satellite subsystem standard model 300 in the satellite simulation modeling system.

When the satellite subsystem standard model 300 is changed, e.g., a data transmission scheme, a data category and a data addition/deletion format are changed between the satellite flight software module 200 and the changed satellite subsystem standard model 300, the model managing unit 100 modifies data link information and model data.

As above, when the satellite subsystem standard model 300 is changed, the flight software module 200 can be built in the satellite simulation modeling system without program code modification by modifying the data link information and model data.

The flight software module 200 generates a control signal to change operation state of the satellite subsystem standard model 300 the satellite state based on control by the model imaging unit 100. The flight software module 200 changes the satellite state and satellite operations by controlling subsystem model as it is done in real satellite system, e. g., the satellite dynamics, the actuator and the sensor.

The satellite subsystem standard model 300 simulates operations of the real physical satellite subsystems and is a component object as the software.

The interface standard model 400 converts the data transmitted from the flight software module 200 and the satellite subsystem standard model 300 the data appropriate to the receiving component, and transmits the data connected to the receiving component.

The interface standard model 400 transmits the satellite simulation data and is a component object independent from the flight software module 200 and the satellite subsystem standard model 300.

Also, the interface standard model 400 possesses the data link information, e.g., a transmission port number between the flight software module 200 and the satellite subsystem standard model 300 and data processing information, e. g., a data format, a data structure and a data attribute independently, and is used for exchanging the satellite simulation data.

Herein, the data link information describes linking information of the data exchanged between the data the hardware device and the software program. For example, the interface standard model 400 determines whether which port (e.g., serial port #100 or parallel port #200) is used for transmitting specific data when the specific data is received to a data port 42 in FIG. 2.

The data processing information describes processing information of the data exchanged between the data the hardware device and the software program. For example, when an electric signal is received from the satellite subsystem standard model 300, the interface standard model 400 performs operations such as amplifying the electric signal or digitalizing the electric signal by analyzing the data format and the data attribute, etc. of the received signal based on the data processing information, and then transmits them to the flight software module 200.

Therefore, when each component is changed and the data to be transmitted is changed, the present invention just modifies the data link information and the data processing information stored in the interface standard model 400 without changing exchanging components that exchanged the data actually, i.e., the flight module 200 and the satellite subsystem standard model 300.

As mentioned above, the present invention implements the flight software module 200, the satellite subsystem standard model 300 and the interface standard model 400 independently by using the model managing unit 100, allocates the components in the satellite simulation modeling system, such that the data is transmitted like that the data is transmitted between the actual satellite subsystems and the flight software. Therefore, the present invention can simulate the actual satellite precisely.

FIG. 2 is a detail block diagram showing a satellite simulation modeling system in accordance with a preferred embodiment of the present invention.

As shown, the interface standard model 400 includes a data processor 40, a data information provider 41, a data port 42 and a data storage 43.

The data processor 40, the data information provider 41 and the data port 42 are independent component objects generated by the model managing unit 100.

The data processor 40 converts data (hereinafter, refers to as the transmission data) transmitted from the flight software module 200 and the satellite subsystem standard model 300 in order to be appropriate data to the receiving component according to the characteristics and the structure of the transmission data.

In detail, the data processor 40 receives the data link information and the data processing information between the flight software module 200 and the satellite subsystem standard model 300 when the data port 42 receives the transmission data. Then, the data processor 40 processes the telemetry data, e.g., state information of satellite posture, acceleration, orbit, communication device and power supply in order to be appropriate data to the flight software module 200 according to the characteristics and the structure of the telemetry data based on telemetry data processing information provided from the data information provider 41.

Meanwhile, the data processor 40 processes the telecommand data transmitted from the flight software module 200 according to the characteristics and the structure of the telecommand data based on telecommand processing information provided from the data information provider 41. Herein, the data processor 40 converts a unit of the transmission data or reconstructs and processes the transmission data, and to thereby transmits the processed transmission data to the corresponding component.

The data information provider 41 extracts the data link information and the data processing information stored in the data storage 43 and transmits them to the data processor 40 when the data is transmitted from the flight software module 200 and the satellite subsystem standard model 300.

The data port 42 receives the transmission data and transmits the transmission data to the data information processor 40, and transmits the transmission data processed in the data processor 40 to the flight software module 200 and the satellite subsystem standard model 300.

The data storage 43 stores the data link information, e.g., telemetry data link information and telecommand data link information, and the data processing information, e.g., telemetry data link processing information and telecommand data processing information, that are needed to process the transmission data in the data processor 40.

As above-mentioned, the method of the present invention can be embodied as a program and stored in recording media (CD-ROM, RAM, floppy disk, hard disk, magneto-optical disk, etc.) readable by a computer.

The present invention converts command data transmitted from the flight software module and the satellite subsystems standard model by using the interface standard model and transmit the converted data to the corresponding receiving component. Therefore, the satellite can be simulated efficiently. Also the present invention modifies the data link information and the data processing information of the interface standard model without replacing the total satellite simulation model system such as the program code when the flight software module or the satellite subsystem standard model is changed. Therefore, reaction to the change of satellite simulation functions is efficient and the present invention can improve the system expansion ability.

The present application contains subject matter related to Korean patent application No. 2003-90766, filed in the Korean Intellectual Property Office on Dec. 12, 2003, the entire contents of which being incorporated herein by reference.

While the present invention has been described with respect to certain preferred embodiments, it will be apparent to those skilled in the art that various changes and modifications may be made without departing from the scope of the invention as defined in the following claims.

1. A satellite simulation modeling system based on an interface standard model, the system comprising:
a satellite subsystem standard model for simulating operations of physical satellite subsystems;
a flight software module for generating a control signal changing operation state of the satellite subsystem standard model;
an interface standard model for converting data transmitted from the satellite subsystem standard model and the flight software module into data to receiving components and transmitting the converted data to the receiving components; and
a model managing means for generating the satellite subsystem standard model and the interface standard model as independent component objects and controlling each component object to perform satellite simulation.

2. The system as recited in claim 1, wherein the interface standard model includes data processing information and data link information, and wherein the data processing information and the data link information are modified when the satellite subsystems standard model is changed.

3. The system as recited in claim 1, wherein the interface standard model includes:
a data processor for converting data transmitted from the satellite subsystem standard model and the flight software module to data appropriate to the receiving component based on characteristics and a structure of the data;
a data information provider for extracting the data link information and the data processing information stored in a data storage and providing the data link information and the data processing information to the data processor;
the data storage for storing the data link information and the data processing information; and
a data port for receiving the data from the satellite subsystem standard model and the flight software module and transmitting the data processed in the data processor to the receiving components.

4. The system as recited in claim 3, wherein the data processor converts telemetry data transmitted from the satellite subsystem standard model to data appropriate to the flight software according to characteristics and a structure of the telemetry data and converts telecommand data transmitted from the flight software module to data appropriate to the satellite subsystem standard module based on telecommand data processing information according to characteristics and a structure of the telecommand data.
